(19) United States
(12) Patent Application Publication
(10) Pub. No.: US 2002/0055914 A1
(43) Pub. Date: May 9, 2002

(54) System and method for distributed knowledge management

(76) Inventors: Dick L. Liu, Saratoga, CA (US); Jane Yung-jen Hsu, Palo Alto, CA (US); Raymond H. Chong, Cupertino, CA (US); Mark B. Chilcott, Fremont, CA (US)

Correspondence Address: WILSON SONSINI GOODRICH & ROSATI, 650 PAGE MILL ROAD, PALO ALTO, CA, 943041050

(21) Appl. No.: 09/798,055

(22) Filed: Mar. 1, 2001

Related U.S. Application Data
(60) Provisional application No. 60/245,847, filed on Nov. 3, 2000.

(51) Int. Cl. G06F 17/00

(52) U.S. Cl. 706/50

(57) ABSTRACT

A system and method for distributed knowledge management. In one embodiment, the system includes a hosted application through which an entity administers a knowledge base (KB). An entity can be, for example, a manufacturer or a reseller of any kind. Administering a KB includes receiving a request for a knowledge item from a user of the system. A user can be an entity or a customer of an entity. Administering further includes responding to the request, which involves accessing knowledge items in at least one of multiple KBs that may be administered by multiple entities. Administering further includes publishing the request, which includes making the request and a response to the request selectively available to different users of the system based upon different levels of privilege assigned to each of the users of the system.

### RELATED APPLICATIONS

This application claims priority to U.S. Provisional Application Serial No. 60/245,847 entitled Distributed Channel Knowledge Management System, filed Nov. 3, 2000.

### FIELD OF THE INVENTION

The invention is in the field of electronic knowledge management in a distributed environment.

### BACKGROUND OF THE DISCLOSURE

Manufacturers of products and service providers increasingly rely on electronically stored data to improve their products and services and to improve customer service. Each entity in the chain of distribution, from an original manufacturer to an end consumer, benefits from access to shared knowledge. For example, a consumer encountering a problem with a product benefits if the reseller who received the product from the manufacturer and sold it to the consumer has access to knowledge about the product that was previously collected by the manufacturer. Currently, however, the reseller may not have practical access to the knowledge of the manufacturer, so it must take the time and use the effort to discover the knowledge itself and convey it to the consumer. With traditional manufacturer-reseller-consumer communications, there is no mechanism in place to efficiently handle the flow of information between these parties. When a customer has a problem, the distribution channel is often designated as the first line of support. In many cases, the reseller does not have adequate access to the full set of manufacturer knowledge, but is still expected to provide a timely and accurate answer to the consumer. The reseller may have access to the manufacturer's knowledge, but accessing the knowledge may require contacting the manufacturer. In many cases, the consumer bypasses the reseller and contacts the manufacturer directly for support, as shown by arrow 100 in FIG. 1, which is a diagram of traditional knowledge management in a distribution system. The traditional model of knowledge management has several disadvantages. For example, the reseller must spend time and effort to attempt to collect knowledge for the consumer, when the knowledge needed may already exist elsewhere in the distribution chain. Another disadvantage is that the consumer is often dissatisfied because the reseller cannot answer inquiries promptly, and so seeks assistance directly from the manufacturer. The manufacturer must spend the time and effort to communicate with the consumer, while possibly communicating with a reseller regarding the identical problem. As a result of these shortcomings, the current mechanisms for knowledge management produce redundant effort with no guarantee of producing timely, satisfactory results.

### SUMMARY OF THE DISCLOSURE

A system and method for distributed knowledge management is described. In one embodiment, the system includes a hosted application through which an entity administers a knowledge base (KB). An entity can be, for example, a manufacturer or a reseller of any kind. Administering a KB includes receiving a request for a knowledge item from a user of the system. A user can be an entity or a customer of an entity. Administering further includes using the KB to respond to the request, which involves accessing knowledge items in at least one of multiple KBs that may be administered by multiple entities. Administering further includes publishing the request and the response, which includes making the request and the response selectively available to different users of the system based upon different levels of privilege assigned to each of the users of the system.

### BRIEF DESCRIPTION OF THE DRAWINGS

FIG. 1 is a diagram of prior art knowledge management in a distribution system.

FIG. 2 is a simplified diagram of one embodiment of a knowledge interchange network.

FIG. 3 is a user interface screen of a knowledge interface network.

FIG. 4 is a user interface screen of a knowledge interface network.

FIG. 5 is a user interface screen of a knowledge interface network.

FIG. 6 is a user interface screen of a knowledge interface network.

FIG. 7 is a user interface screen of a knowledge interface network.

FIG. 8 is a user interface screen of a knowledge interface network.

FIG. 9 is a user interface screen of a knowledge interface network.

FIG. 10 is a diagram of one embodiment of a channel topology of a knowledge interchange network.

FIG. 11 is a table listing elements of the channel topology of FIG. 10.

FIG. 12 is a diagram of groups as defined by an entity.

FIG. 13 is a table showing filters defined by an entity.

FIG. 14 is a table summarizing access rights to knowledge items as defined by an entity.

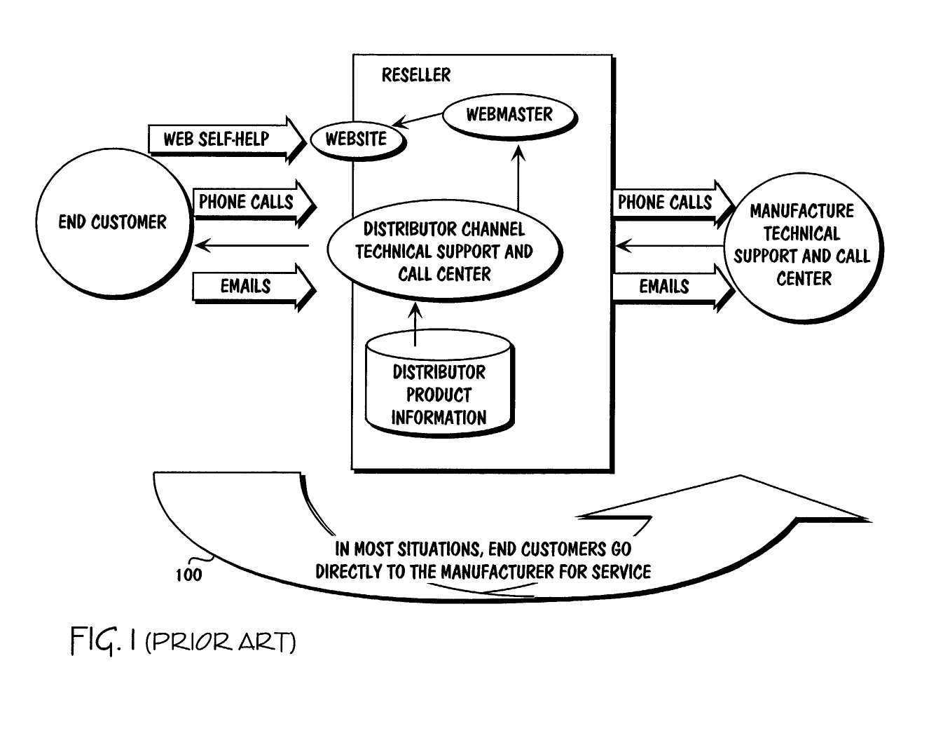

### DETAILED DESCRIPTION

A system and method for distributed knowledge management is described. In one embodiment, the system includes a hosted application available over a network, such as the Internet. In one embodiment, a manufacturer maintains a knowledge base (KB) with up-to-date product and service information. Using access rights assigned by the manufacturer, a distributor further down the distribution chain (e.g., a retailer or original equipment manufacturer (OEM), collectively referred to herein as “resellers”) can easily and selectively modify and replicate knowledge items from the manufacturer's KB into its own KB. The manufacturer's KB tracks which resellers have replicated which knowledge items and the manufacturer automatically notifies those resellers of changes to replicated items. The reseller is essentially linked to a replicated version of the manufacturer's knowledge base, for example through an Internet link. The replicated version of the manufacturer's knowledge base contains selected knowledge items from the manufacturer's knowledge base in their original or a modified form, in addition to any other knowledge items that the reseller wishes to make available to its customers.

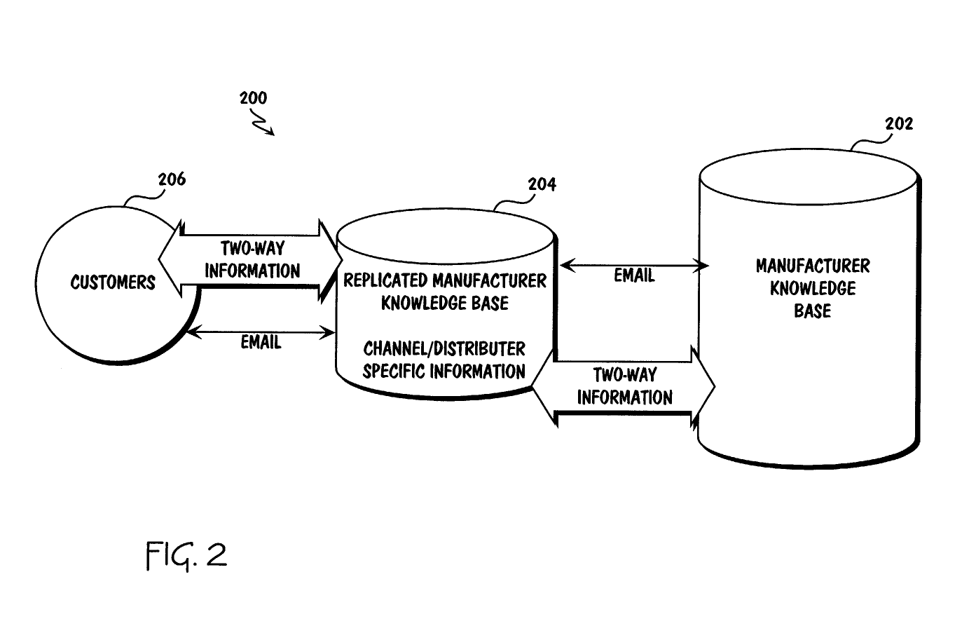

FIG. 2 is a simplified diagram of part of a knowledge interchange network 200 through which different entities share knowledge. An entity, as referred to herein, is a business entity such as a manufacturer or a reseller. A reseller can be any entity that receives a product or service from a manufacturer and resells it. In one embodiment, the entities communicate via the Internet. Manufacturer KB 202 contains detailed information chiefly intended for technical support professionals. The manufacturer KB 202 communicates with the reseller KB 204. The reseller KB 204 contains reseller specific information and, as explained more fully below, a replicated manufacturer KB. In general a KB in the network contains knowledge items such as product descriptions, frequently asked questions (FAQs), frequently used files/documents, decision processes, customer inquiries and solutions (e.g., “trouble tickets”), customer profile information and statistics, and customer feedback. Customers 206 are customers of the reseller who communicate with the reseller via the Internet and are also considered end-users of the product or service. Multiple entities of various types may participate in the knowledge interchange network. For example, multiple resellers may communicate with each other and with a common manufacturer. As end users submit support inquiries to a reseller, knowledge resulting from the inquiry is shared among participants in the network. In addition, as the manufacturer updates knowledge in its KB, that knowledge is automatically made available to network participants, who may choose to add the information to their respective KBs. For example, when the manufacturer updates a knowledge item regarding a product, each reseller in the network that has the appropriate privileges is notified automatically by email. The reseller may modify the knowledge item and store it, or store the knowledge item unmodified. For example, the reseller may wish to replicate only part of a knowledge item from the manufacturer. The reseller may also publish selected items in original or edited (re-branded) form. The reseller thus gains a replicated manufacturer KB so that customers making support inquiries to the reseller have all of the knowledge in the network available to them.

A KB can be accessed in a “self-help” mode or an “inquiry” mode. Typically, in self-help mode, a user receives a list of relevant knowledge items collected from the database as a result of a search based upon a submitted word or phrase. A customer might use self-help mode to access information directly. A customer representative might also use self-help mode to gather knowledge items for answering an inquiry. In inquiry mode, on the other hand, the user receives an answer to a query. The answer may be based upon items from the KB and is typically formulated by a customer representative.

The knowledge interchange network 200 significantly enhances the ease and efficiency of existing support mechanisms by making more complete and current information available at the reseller KB. For example, customers 206 may access the reseller KB 204 for knowledge in the form of text, audio and video. The reseller KB 204 can be structured in any way and the knowledge items may be variously formatted. The customer 206 can access FAQs or interactive FAQs. An interactive FAQ is an interactive consultation session that enables a question and answer dialogue between a customer support representative and a customer 206.

If the customer 206 is unable to find answers by browsing or searching the reseller KB 204, the customer 206 can submit a tracked email inquiry to the reseller. In one embodiment, the email inquiry is automatically routed to an appropriate customer support representative. When the representative answers the inquiry, he or she has the option to publish the information by updating the reseller KB with the knowledge gained. If the reseller is not able to answer the inquiry, the original customer email can be forwarded to the manufacturer for response. The manufacturer accesses its KB 202 and responds to the reseller, who responds to the customer 206 in turn. Thus, the customer sees a consistent interface with the reseller. The reseller can update the KB 204 after the question is answered, and the manufacturer can update the KB 202. Updating eliminates the need for future emails regarding the question. The manufacturer or reseller can then notify the entire network of the new or updated information, and each participating entity has the option to update its respective KB with the knowledge.

In one embodiment, each entity “owns” a KB and can create and publish knowledge items into its own KB. The entity can be both a producer/supplier and a consumer of knowledge items. The entity can authorize other entities to access and reuse the entity's KB and the entity can supply knowledge items for reuse and/or distribution.

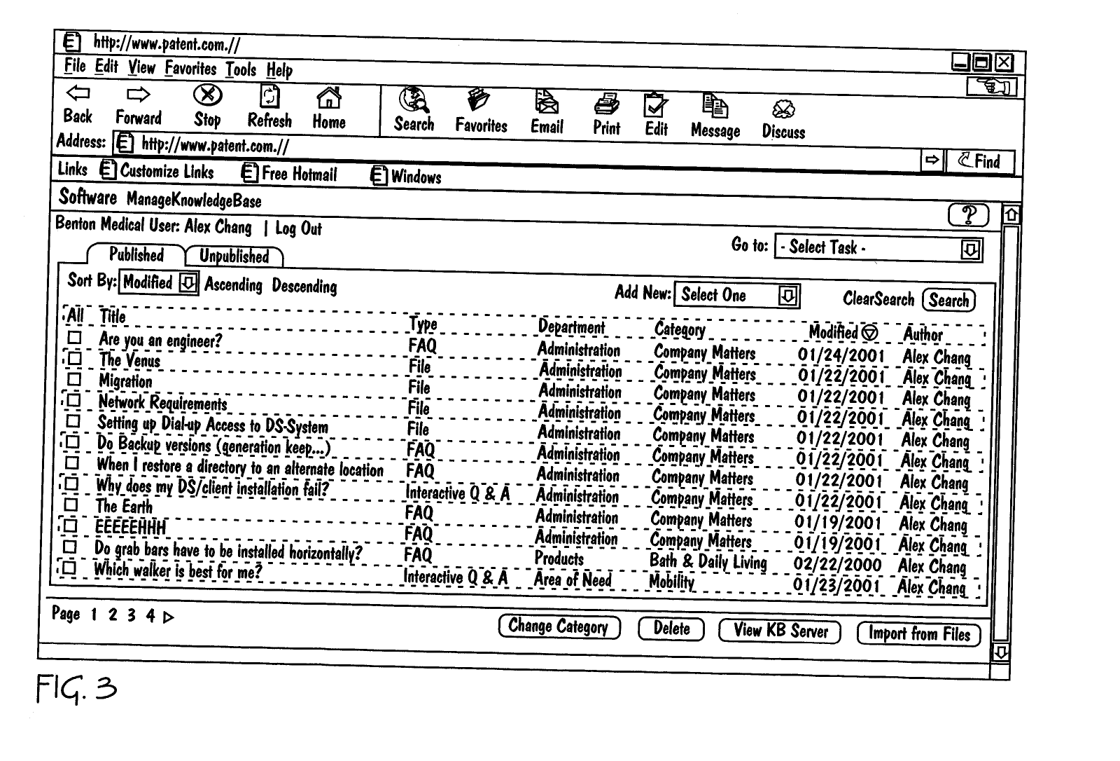

FIGS. 3 through 9 show examples of knowledge interchange network functionality illustrated by user interface screens.

Consider the following two companies in the example knowledge interchange network of FIGS. 3 through 9. Let A be the knowledge producer, DSTelevaulting, and let B be the knowledge consumer, Benton Medical. FIG. 3 shows the list of knowledge items currently published in B's knowledge base as viewed from its “Manage Knowledge Base” function. A customer service representative (“CSR”) can perform a number of functions using the following buttons/menu:

Change Category is used to change the category of all checked KB items; Delete is used to delete the checked KB items;

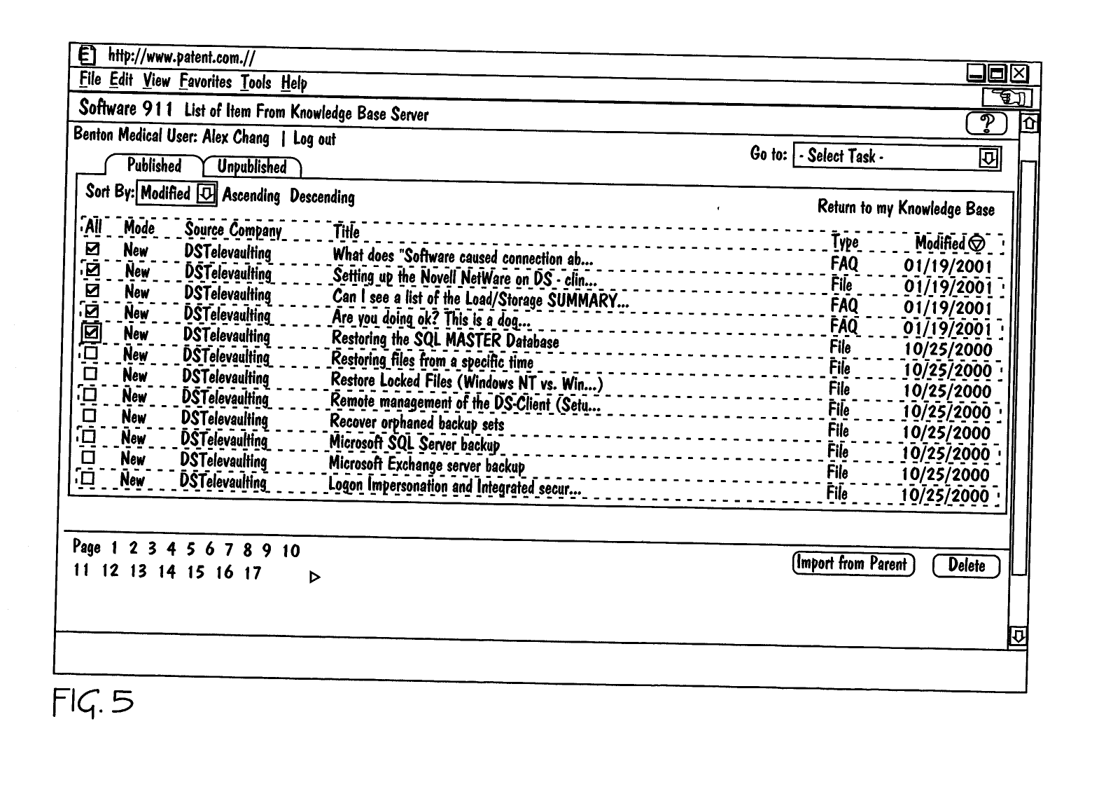

View KB Server is used to view the list of newly published, updated, and deleted KB items from B's parent companies, such as A (more details are described in FIG. 5);

Import from Files will batch import one or more KB items (written in a simple tagged text format) from files.

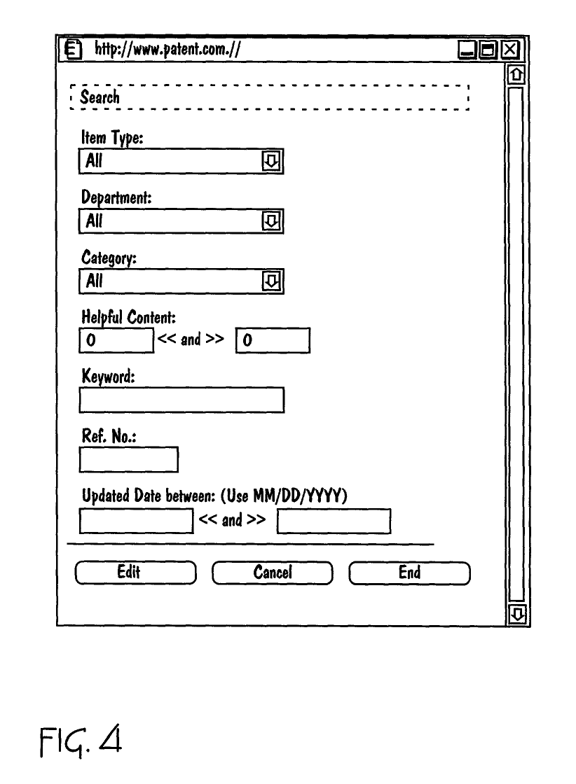

The “Add New” drop-down menu shown in FIG. 3 allows the addition of a new FAQ, Interactive Q&A, or any other type of document. Clicking the “Search” button on the upper right hand corner will bring up the screen shown in FIG. 4. This allows the CSR to restrict the KB items listed by a number of properties, such as Category or Keyword etc., of the KB items.

FIG. 5 shows the screen displayed when the CSR of Company B wishes to import KB items from its parent company A by clicking the “View KB Server” button. The KB items can be sorted according to their modification dates, title, or type. The mode of each KB item can be one of “New”, “Updated” and “Deleted”.

The “Import from Parent” button allows duplication of the checked KB items from the parent's KB. The “Delete” button indicates that the KB items not checked are not to be duplicated, and are not to be displayed as candidates for future KB duplication.

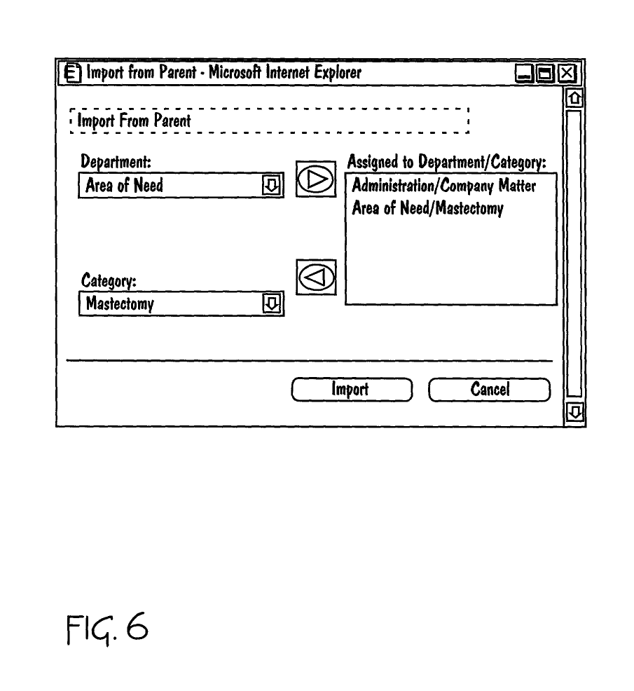

By checking the boxes in front of the appropriate KB items, a CSR may duplicate one or more KB items at one time. Upon clicking the “Import from Parent” button, a window as shown in FIG. 6 pops up requesting manual classification of the imported KB items into B's category structure.

As is illustrated in this example, the selected KB items may be classified into one or more categories. The categories of Company A and Company B do not have to be identical. Once the categories are defined, the CSR can click the “Import” button to duplicate the KB items.

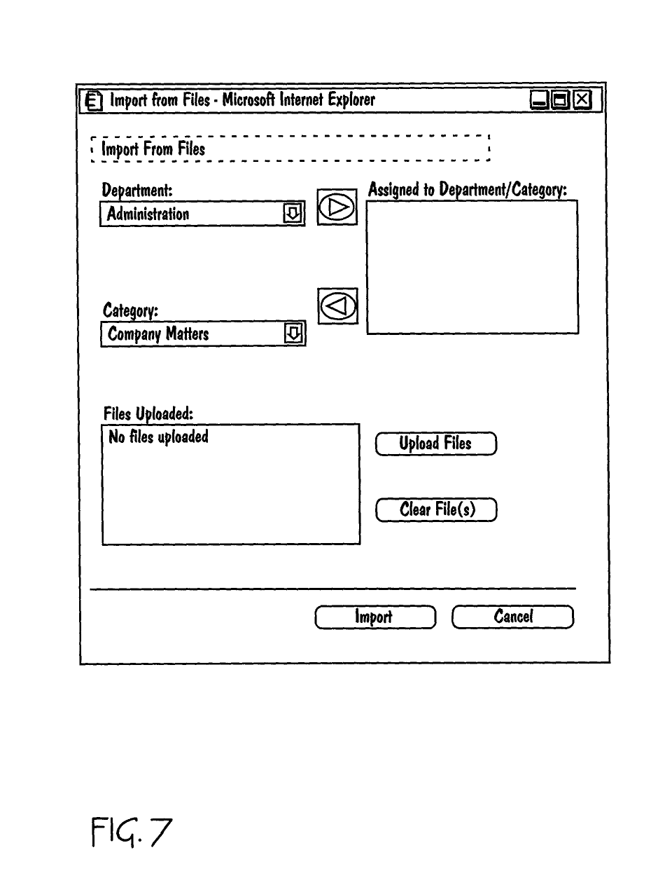

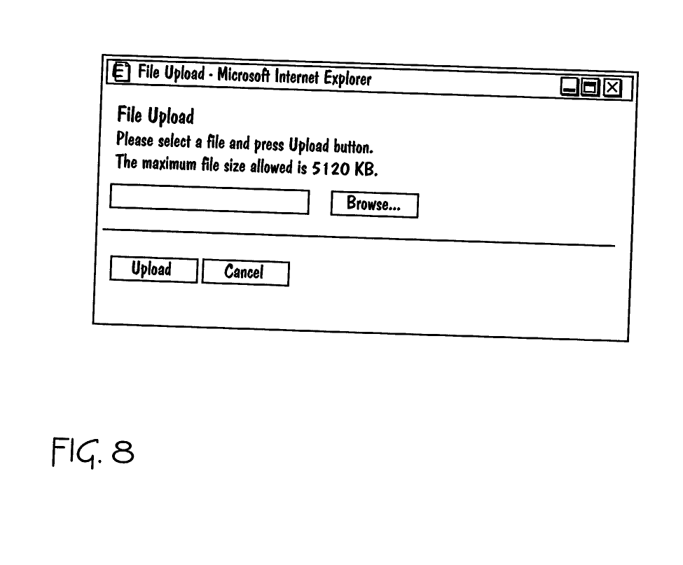

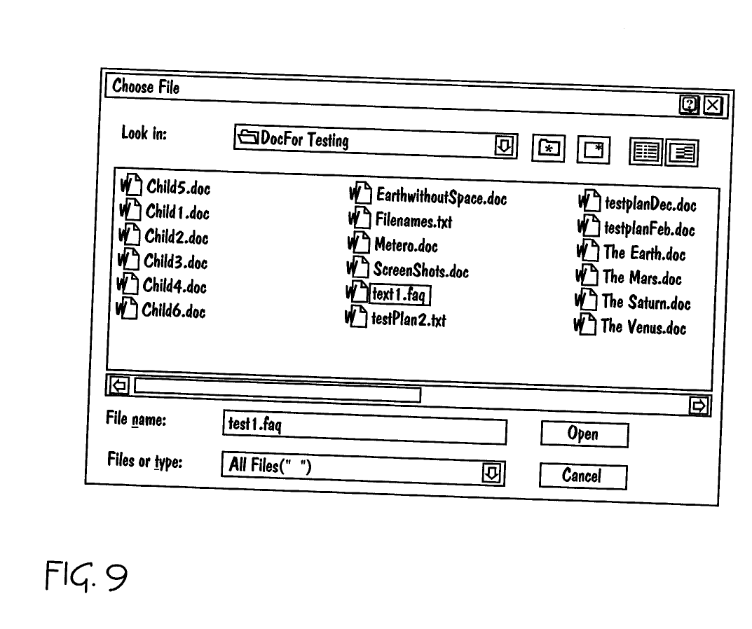

Alternatively, a CSR may add multiple KB items into a company's KB at one time by using the “Import from Files” function. FIG. 7 shows the screen, in which a CSR assigns the categories of all KB items in the uploaded files. FIGS. 8 and 9 show screens for uploading and browsing the files. Each uploaded file may contain the definitions of one or more FAQ's in a tagged text format as follows.

<faq>

<question>

This is the question.

</question>

<answer>

This is the answer

</answer>

</faq>

In addition, an uploaded file may be of any of the standard file types, such as DOC, PDF, GIF, etc. The uploaded file will be imported as a new non-FAQ KB item.

In one embodiment, the knowledge interchange network includes three layers, a channel layer, an authorization layer, and a knowledge layer.

The knowledge interchange network defines a directed graph of nodes and directed links in which each node represents an entity and each directed link represents a channel from a producer of a knowledge item to a consumer of the knowledge item. Each node may have multiple incoming and/or outgoing links. Between any two nodes in the network, there is at most one channel in each direction. No directed link from a node back to itself is allowed.

As an example, a knowledge interchange network includes the following entities: M1, a manufacturer of global positioning system (GPS) equipment, with separate OEM and consumer product lines; M2, which manufactures automotive accessories; OEM1 and OEM2, which are car manufacturers that rebrand M1's products with their own names; Reseller1 and Reseller2, which are traditional consumer retail channels for M1; and Reseller3, which is a traditional consumer retail channel for OEM1.

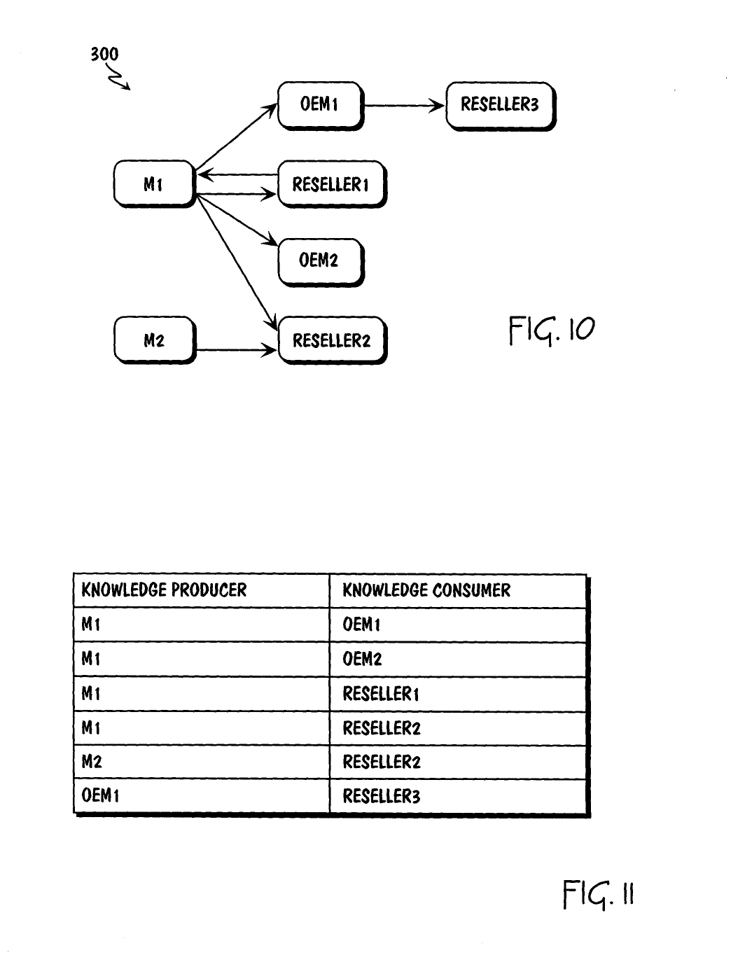

The channel layer will be discussed with reference to FIG. 10, which is a diagram of the channel topology 300 of an example knowledge interchange network. The entities in the channel topology 300 have various knowledge requirements. For example, suppose that M1 publishes product specifications for the GPS systems that it manufactures. The published knowledge items will be partially available to its distributed reseller and OEM channels so that the OEM channels can provide accurate and useful information to their prospective customers. The directed path from one entity to another defines the channel of knowledge distribution if the knowledge producer grants the access and the knowledge consumer accepts it as a credible source. Access control is discussed more fully below with reference to the authorization layer. On the other hand, two business entities will not share any knowledge if there is no path between the corresponding nodes in the channel topology 300.

The channel topology 300 can be represented as a table. For example, each row in the table of FIG. 11 defines a channel in the channel topology 300.

The authorization layer defines what can be distributed through the knowledge channels. An entity may produce knowledge items to be used by different groups of users for a variety of purposes. For example, M1 produces separate information for its OEM and consumer product lines. In addition, M1 may produce privileged or proprietary information for its preferred channels. For example, M1 is engaged in a joint study of new user interface with OEM1, while co-developing a detachable unit with OEM2. As a result, it is necessary to have a mechanism that controls the flow of different knowledge items through the channels.

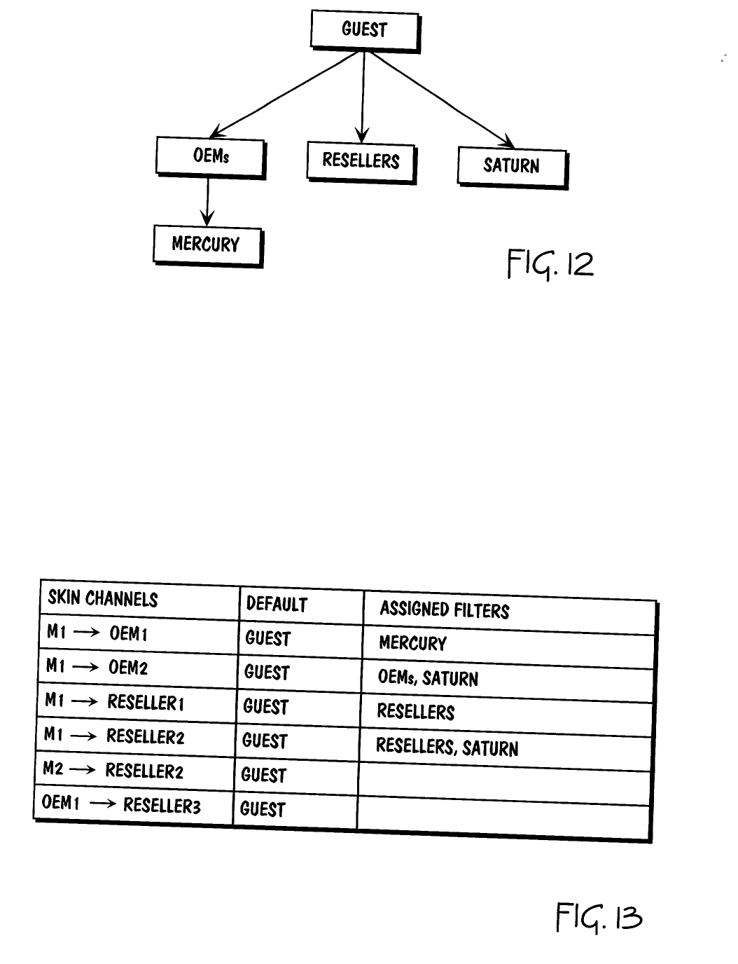

In one embodiment, each business entity defines one or more access control filters over its outgoing channels. Multiple filters may be associated with a single channel. A group-based authorization mechanism is used for access control. That is, each filter is assigned a unique group that defines the type of knowledge that can pass through the filter. For example, M1 defines the groups shown in the diagram of FIG. 12, in which OEMs, Resellers, and Saturn are sub-groups of Guest, and Mercury is a sub-group of OEMs.

A default filter belonging to the “Guest” group is associated with every channel defined in the knowledge interchange network. Groups are partially ordered, e.g. Guest>OEMs>Mercury in this example. A filter belonging to a group such as Mercury, belongs implicitly to all of its super-groups, such as OEMs and Guest.

FIG. 13 is a table showing the filters that have been associated with the channels in the knowledge interchange network.

The knowledge layer allows definition of the way in which knowledge items are replicated over a distribution channel in the knowledge interchange network once the filters are in place. The entity decides which knowledge items owned by the entity can be replicated by any other business entity. At the knowledge layer, each entity assigns at least one group for each knowledge item by defining the group property for: the entire KB; any product/category; and/or any individual knowledge item.

By default, all knowledge items belong to the Guest group, and are accessible by all customers as well as all entities in the knowledge interchange network. Multiple groups may be assigned to a single knowledge item. A knowledge item k can pass through a filter f if and only if it has been assigned a group g, such that g is greater than or equal to Group(f). As a result, for any business entities B₁ and B₂, the entity B₂ is authorized to access a knowledge item k owned by the entity B₁ if and only if: there is a channel from B₁ to B₂; and for some g assigned to k and some filter f associated with the given channel, g is greater than or equal to Group(f).

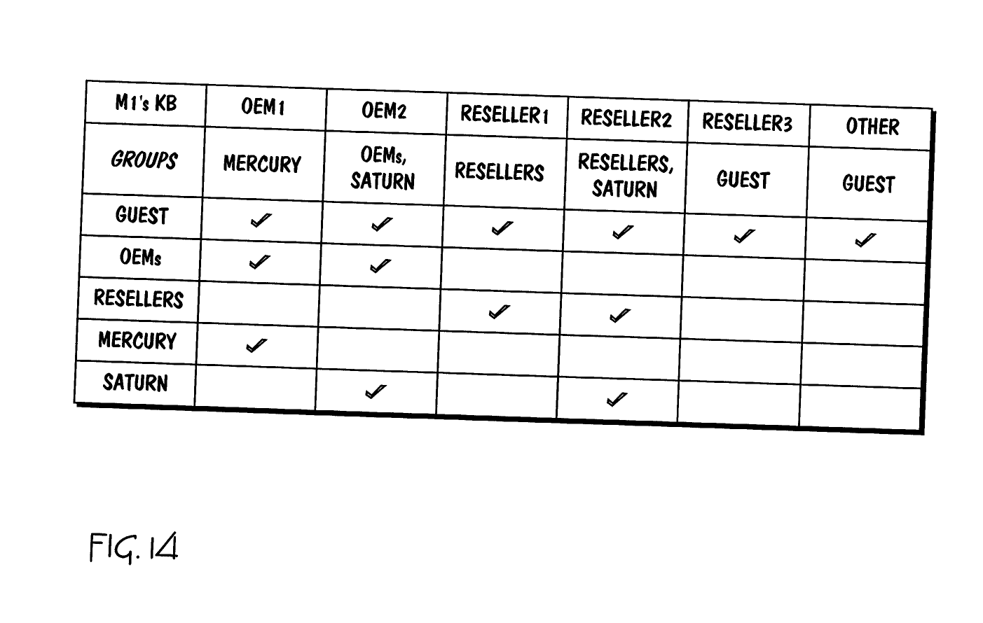

Continuing with the same example, FIG. 14 is a table summarizing the access rights to any knowledge item in M1's KB. Given that each channel from M1 to any specific business entity (in the top row) is associated with one or more filters (in the second row). If a knowledge item belongs to some group on the first column, it is accessible via the channel corresponding to the column with a check mark. For instance, knowledge items belonging to the OEMs group are accessible by business entities OEM1 and OEM2. The access rights to knowledge items with assigned groups M2, OEM1, etc., can be defined similarly.

In the knowledge layer, it is also possible to define when and/or how often the knowledge is replicated and shared, whether a knowledge item is replicated as a result of producer push or consumer pull, and whether the replicated knowledge item can be modified and/or updated. In one embodiment, knowledge is replicated and shared when a new knowledge item is created or an existing knowledge item is modified. Replication takes place as a result of consumer pull. The knowledge consumer is free to modify or rebrand a knowledge item from its original producer. When the knowledge consumer modifies a knowledge item, the knowledge consumer becomes the producer of the modified knowledge item.

The invention has been described with reference to specific embodiments. The invention is not limited to the embodiments described, but is defined by the following claims.

What is claimed is:

1. A system for managing knowledge in a distributed environment, comprising:
a plurality of knowledge bases (KBs), wherein each of the plurality of KBs is administered by one of a plurality of entities;
a hosted application through which at least one entity of the plurality of entities administers a corresponding KB, wherein administering a KB includes,
receiving a request for a knowledge item from one of a plurality of users of the system, wherein the plurality of users comprises the plurality of entities and customers of the at least one entity and;
responding to the request, wherein responding comprises accessing knowledge items in at least one of the plurality of KBs; and
publishing the request, wherein publishing comprises making the request and a response to the request selectively available to different users of the system based upon different levels of access privilege assigned to each of the users of the system.

2. The system of claim 1, wherein the plurality of entities comprises a manufacturer and a reseller, and wherein administering further comprises KB replication, wherein KB replication includes:
the reseller viewing at least one knowledge item in a KB administered by the manufacturer;
the reseller importing the at least one knowledge item, wherein importing includes specifying at least one knowledge item according to at least one criterion;
the reseller editing the at least one knowledge item; and
the reseller publishing the at least one knowledge item, wherein publishing further comprises storing the at least one knowledge item in a KB administered by the reseller.

3. The system of claim 2, wherein the at least one criterion is selected from a group comprising, modification date; title; type; whether the at least one knowledge item is new; whether the at least one knowledge item is updated; and whether the at least one knowledge item is deleted.

4. The system of claim 2, wherein importing further includes specifying a category under which the at least one knowledge item is to be imported to the KB administered by the reseller, wherein the category specified may differ from a category assigned by the manufacturer.

5. The system of claim 2, wherein importing further comprises importing from files, wherein the at least one knowledge item is stored by the manufacturer in a pre-defined file format.

6. The system of claim 2, wherein responding comprises:
in response to the reseller receiving a request for knowledge from a customer of the reseller, the reseller accessing the KB administered by the reseller transparently to the customer; and
in response to the reseller receiving the request for a knowledge item from the customer of the reseller, the reseller accessing the KB administered by the manufacturer transparently to the customer; and
the reseller conveying at least one knowledge item from the KB administered by the manufacturer to the customer transparently to the customer.

7. The system of claim 6, wherein the hosted application includes a plurality of user interfaces comprising a customer portal and an administrative portal, wherein the customer and the reseller interact through a customer portal of the reseller, and the manufacturer and the reseller interact with each other through a customer portal of the manufacturer and an administrative portal of the reseller.

8. The system of claim 7, wherein the customer portal includes a self-help function wherein a user directly accesses at least one knowledge item from at least one of the plurality of KBs, and wherein the at least one knowledge item comprises a frequently asked question (FAQ) and an interactive FAQ.

9. The system of claim 8, wherein directly accessing includes browsing a KB using predefined categories and sub-categories, and keyword searching.

10. The system of claim 6, wherein the administrative portal includes an administrative function wherein the reseller and the manufacturer assign different levels of KB access privilege to different users.

11. The system of claim 10, wherein the plurality of entities is coupled through a multi-layer knowledge interchange network comprising a channel layer, an authorization layer, and a knowledge layer.

12. The system of claim 11, wherein each of the plurality of entities comprises a node that communicates with other nodes through channels, wherein a directed link couples two nodes and comprises a channel from a producer of a knowledge item to a consumer of the knowledge item if the producer grants access to the consumer and the consumer acknowledges the producer as an approved knowledge source.

13. The system of claim 12, wherein an entity assigns a user to at least one of a plurality of groups within the authorization layer.

14. The system of claim 13, wherein the entity defines at least one access control filter for a channel, and wherein each access control filter is assigned a group of the plurality of groups, wherein the assigned group defined a type of knowledge item that can pass through the at least one access control filter.

15. The system of claim 14, wherein an entity controls access to knowledge items through the knowledge layer, comprising the entity assigning at least one group within the knowledge layer to a knowledge item, wherein assigning comprises defining a group property for at least one of: a KB administered by the entity; a product; a category of product; and an individual knowledge item.

16. The system of claim 15, wherein access includes viewing a knowledge item, modifying a knowledge item, replicating a knowledge item, and publishing a knowledge item.

17. The system of claim 16, wherein a hierarchical relationship exists between groups, and wherein a knowledge item k can pass through filter f if and only if some group g assigned to k is greater than or equal to Group (f).

18. The system of claim 17, wherein a knowledge item is replicated and published when a new knowledge item is created or an existing knowledge item is modified.

19. The system of claim 17, wherein replication occurs when an entity requests a knowledge item, and wherein the entity becomes a producer of the knowledge item when the entity modifies the knowledge item.

20. A method for managing knowledge in a distributed environment in which a plurality of entities each owns at least one of a plurality of knowledge bases (KBs), the method comprising:
an entity administering a KB owned by the entity through a hosted application, wherein administering the KB comprises,
receiving a request for a knowledge item from one of a plurality of users of the system, wherein the plurality of users comprises the plurality of entities and customers of the at least one entity and;
responding to the request, wherein responding comprises accessing knowledge items in at least one of the plurality of KBs; and
publishing the request, wherein publishing comprises making the request and a response to the request selectively available to different users of the system based upon different levels of access privilege assigned to each of the users of the system.

21. The method of claim 20, wherein the plurality of entities comprises a manufacturer and a reseller, and wherein administering further comprises KB replication, wherein KB replication includes:
the reseller viewing at least one knowledge item in a KB administered by the manufacturer;
the reseller importing the at least one knowledge item, wherein importing includes specifying at least one knowledge item according to at least one criterion;
the reseller editing the at least one knowledge item; and
the reseller publishing the at least one knowledge item, wherein publishing further comprises storing the at least one knowledge item in a KB administered by the reseller.

22. The method of claim 21, wherein the at least one criterion is selected from a group comprising, modification date; title; type; whether the at least one knowledge item is new; whether the at least one knowledge item is updated; and whether the at least one knowledge item is deleted.

23. The method of claim 21, wherein importing further includes specifying a category under which the at least one knowledge item is to be imported to the KB administered by the reseller, wherein the category specified may differ from a category assigned by the manufacturer.

24. The method of claim 21, wherein importing further comprises importing from files, wherein the at least one knowledge item is stored by the manufacturer in a pre-defined file format.

25. The method of claim 21, wherein responding comprises:
in response to the reseller receiving a request for knowledge from a customer of the reseller, the reseller accessing the KB administered by the reseller transparently to the customer; and
in response to the reseller receiving the request for a knowledge item from the customer of the reseller, the reseller accessing the KB administered by the manufacturer transparently to the customer; and
the reseller conveying at least one knowledge item from the KB administered by the manufacturer to the customer transparently to the customer.

26. The method of claim 25, wherein the hosted application includes a plurality of user interfaces comprising a customer portal and an administrative portal, wherein the customer and the reseller interact through the customer portal and the manufacturer and the reseller interact with each other and with other entities through the administrative portal.

27. The method of claim 26, wherein the customer portal includes a self-help function wherein a user directly accesses at least one knowledge item from at least one of the plurality of KBs, and wherein the at least one knowledge item comprises a frequently asked question (FAQ) and an interactive FAQ.

28. The method of claim 27, wherein directly accessing includes browsing a KB using predefined categories and sub-categories, and keyword searching.

29. The method of claim 25, wherein the administrative portal includes an administrative function wherein the reseller and the manufacturer assign different levels of KB access privilege to different users.

30. The method of claim 29, wherein the plurality of entities is coupled through a multi-layer knowledge interchange network comprising a channel layer, an authorization layer, and a knowledge layer.

31. The method of claim 30, wherein each of the plurality of entities comprises a node that communicates with other nodes through channels, wherein a directed link couples two nodes and comprises a channel from a producer of a knowledge item to a consumer of the knowledge item if the producer grants access to the consumer and the consumer acknowledges the producer as an approved knowledge source.

32. The method of claim 31, wherein an entity assigns a user to at least one of a plurality of groups within the authorization layer.

33. The method of claim 32, wherein the entity defines at least one access control filter for a channel, and wherein each access control filter is assigned a group of the plurality of groups, wherein the assigned group defined a type of knowledge item that can pass through the at least one access control filter.

34. The method of claim 33, wherein an entity controls access to knowledge items through the knowledge layer, comprising the entity assigning at least one group within the knowledge layer to a knowledge item, wherein assigning comprises defining a group property for at least one of: a KB administered by the entity; a product; a category of product; and an individual knowledge item.

35. The method of claim 34, wherein access includes viewing a knowledge item, modifying a knowledge item, replicating a knowledge item, and publishing a knowledge item.

36. The method of claim 3 5, wherein a hierarchical relationship exists between groups, and wherein a knowledge item k can pass through filter f if and only if some group g assigned to k is greater than or equal to Group (f).

37. The method of claim 36, wherein a knowledge item is replicated and published when a new knowledge item is created or an existing knowledge item is modified.

38. The method of claim 37, wherein replication occurs when an entity requests a knowledge item, and wherein the entity becomes a producer of the knowledge item when the entity modifies the knowledge item.

39. An electromagnetic medium containing executable instructions which, when executed in a processing system, cause the system to manage knowledge in a distributed environment, wherein managing knowledge comprises:
an entity administering a KB owned by the entity through a hosted application, wherein administering the KB comprises,
receiving a request for a knowledge item from one of a plurality of users of the system, wherein the plurality of users comprises the plurality of entities and customers of the at least one entity and;
responding to the request, wherein responding comprises accessing knowledge items in at least one of the plurality of KBs; and
publishing the request, wherein publishing comprises making the request and a response to the request selectively available to different users of the system based upon different levels of access privilege assigned to each of the users of the system.

40. The electromagnetic medium of claim 39, wherein the plurality of entities comprises a manufacturer and a reseller, and wherein administering further comprises KB replication, wherein KB replication includes:
the reseller viewing at least one knowledge item in a KB administered by the manufacturer;
the reseller importing the at least one knowledge item, wherein importing includes specifying at least one knowledge item according to at least one criterion;
the reseller editing the at least one knowledge item; and
the reseller publishing the at least one knowledge item, wherein publishing further comprises storing the at least one knowledge item in a KB administered by the reseller.

41. The electromagnetic medium of claim 40, wherein the at least one criterion is selected from a group comprising, modification date; title; type; whether the at least one knowledge item is new; whether the at least one knowledge item is updated; and whether the at least one knowledge item is deleted.

42. The electromagnetic medium of claim 40, wherein importing further includes specifying a category under which the at least one knowledge item is to be imported to the KB administered by the reseller, wherein the category specified may differ from a category assigned by the manufacturer.

43. The electromagnetic medium of claim 40, wherein importing further comprises importing from files, wherein the at least one knowledge item is stored by the manufacturer in a pre-defined file format.

44. The electromagnetic medium of claim 40, wherein responding comprises:
in response to the reseller receiving a request for knowledge from a customer of the reseller, the reseller accessing the KB administered by the reseller transparently to the customer; and
in response to the reseller receiving the request for a knowledge item from the customer of the reseller, the reseller accessing the KB administered by the manufacturer transparently to the customer; and
the reseller conveying at least one knowledge item from the KB administered by the manufacturer to the customer transparently to the customer.

45. The electromagnetic medium of claim 44, wherein the hosted application includes a plurality of user interfaces comprising a customer portal and an administrative portal, wherein the customer and the reseller interact through the customer portal and the manufacturer and the reseller interact with each other and with other entities through the administrative portal.

46. The electromagnetic medium of claim 45, wherein the customer portal includes a self-help function wherein a user directly accesses at least one knowledge item from at least one of the plurality of KBs, and wherein the at least one knowledge item comprises a frequently asked question (FAQ) and an interactive FAQ.

47. The electromagnetic medium of claim 46, wherein directly accessing includes browsing a KB using predefined categories and sub-categories, and keyword searching.

48. The electromagnetic medium of claim 44, wherein the administrative portal includes an administrative function wherein the reseller and the manufacturer assign different levels of KB access privilege to different users.

49. The electromagnetic medium of claim 48, wherein the plurality of entities is coupled through a multi-layer knowledge interchange network comprising a channel layer, an authorization layer, and a knowledge layer.

50. The electromagnetic medium of claim 49, wherein each of the plurality of entities comprises a node that communicates with other nodes through channels, wherein a directed link couples two nodes and comprises a channel from a producer of a knowledge item to a consumer of the knowledge item if the producer grants access to the consumer and the consumer acknowledges the producer as an approved knowledge source.

51. The electromagnetic medium of claim 50, wherein an entity assigns a user to at least one of a plurality of groups within the authorization layer.

52. The electromagnetic medium of claim 51, wherein the entity defines at least one access control filter for a channel, and wherein each access control filter is assigned a group of the plurality of groups, wherein the assigned group defined a type of knowledge item that can pass through the at least one access control filter.

53. The electromagnetic medium of claim 52, wherein an entity controls access to knowledge items through the knowledge layer, comprising the entity assigning at least one group within the knowledge layer to a knowledge item, wherein assigning comprises defining a group property for at least one of: a KB administered by the entity; a product; a category of product; and an individual knowledge item.

54. The electromagnetic medium of claim 53, wherein access includes viewing a knowledge item, modifying a knowledge item, replicating a knowledge item, and publishing a knowledge item.

55. The electromagnetic medium of claim 54, wherein a hierarchical relationship exists between groups, and wherein a knowledge item k can pass through filter f if and only if some group g assigned to k is greater than or equal to Group (f).

56. The electromagnetic medium of claim 55, wherein a knowledge item is replicated and published when a new knowledge item is created or an existing knowledge item is modified.

57. The electromagnetic medium of claim 56, wherein replication occurs when an entity requests a knowledge item, and wherein the entity becomes a producer of the knowledge item when the entity modifies the knowledge item.
